(19) United States
(12) Patent Application Publication
(10) Pub. No.: US 2009/0076811 A1
(43) Pub. Date: Mar. 19, 2009

(54) Decision Analysis System

(76) Inventor: Ilan Ofek, Singapore (SG)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/944,494

(22) Filed: Nov. 23, 2007

(30) Foreign Application Priority Data
Sep. 13, 2007 (SG) 200708775-2

(51) Int. Cl. G10L 15/00

(52) U.S. Cl. 704/231; 704/E15.001

(57) ABSTRACT

A decision analysis system (10) for analyzing voice data is disclosed. The system comprises a voice collection device 12 arranged to capture voice data from a human speaker, and a processing system (14). The processing system (14) is arranged to parse the captured voice data so as to produce a plurality of emotion parameter values (72) indicative of emotional content of the voice data, each parameter value (72) being indicative of the level of an emotion parameter present in the captured voice data, and to generate an indication as to quality of a decision made by the human speaker using a combination of a plurality of the parameter values (72). A corresponding method is also disclosed.

### FIELD OF THE INVENTION

The present invention relates to a decision quality analysis system, in particular to a decision analysis system using human voice stream data so as to determine the quality of decision making, and to a method of analysing a decision using human voice data.

### BACKGROUND OF THE INVENTION

It is known to provide a system for analyzing and detecting emotion and/or an emotional state of a user from voice information. In one such arrangement, voice information from a user is analyzed for example in a call centre in order to determine an emotional state of the user and thereby an indication of the urgency of the message as well as the reliability of the message. A further such system is arranged to detect the level of nervousness in a person using voice data and to use the information in business in order to combat fraud during contract negotiation, insurance claims, and so on.

However, while existing systems are able to analyze voice data and provide an indication as to the emotional state of a person associated with the voice data, such systems are of limited use in some applications such as military applications as only a general indication as to the emotional state of a person is possible.

### SUMMARY OF THE INVENTION

In accordance with an aspect of the present invention, there is provided a decision quality analysis system for analyzing voice data, said system comprising:
a voice input device arranged to capture voice data from a human speaker; and
a processing system arranged to:
   parse the captured voice data so as to produce a plurality of emotion parameter values indicative of emotional content of the voice data, each parameter value being indicative of the level of an emotion parameter present in the input voice data; and
   generate an indication as to quality of a decision made by the human speaker using a combination of a plurality of the parameter values.

In one arrangement, the processing system is arranged to generate a Decision Quality Value indicative of the quality of a decision using a combination of a plurality of the parameter values.

In one arrangement, the processing system is arranged to generate a plurality of Decision Quality Indices which may comprise a Risk Index, a Maturity Thinking Index and an Emotion Index. Each Decision Quality Index may be derived from a plurality of parameter values.

In one embodiment, each Decision Quality Index is a number between 0 and 1.

In one arrangement, the input voice data is parsed so as to produce a plurality of emotion parameter values using a voice analysis component (e.g. Nemesysco's LVA).

In one embodiment, the Risk Index is calculated according to:

$$Risk Index = Hesitation \times {N}_{1} \times {W}_{h} + Stress \times {N}_{1} \times {W}_{s} + Excitement \times {N}_{1} \times {W}_{e} + Anticipation \times {N}_{1} \times {W}_{a} + Intensive Thinking \times {N}_{1} \times {W}_{int} + Imagination \times {N}_{1} \times {W}_{img} + Uncertain \times {N}_{1 \times } {W}_{u}$$

### Where:

Wₕ+Wₛ+Wₑ+Wᵢₙₜ=0.7

Wₐ+W_{ing}+Wᵤ=0.3

N1 is a normalization parameter, which constrain the value of risk index in the range of 0˜1

In one embodiment, the Maturity Thinking Index is calculated according to:

$$Maturity Index = Hesitation \times {N}_{1} \times {W}_{h} - Uncertain \times {N}_{1} \times {W}_{u} - Excitement \times {N}_{1} \times {W}_{e} + Concentrated \times {N}_{1} \times {W}_{c} - Extreme Emotion \times {N}_{1} \times {W}_{ext}$$

### Where:

Wₕ+Wₑ+Wᵤ+W_{c}=0.9

Wₑₓₜ=0.1

N1 is a normalization parameter, which constrain the value of risk index in the range of 0˜1

In one embodiment, the Emotion Index is calculated according to:

$$Emotion Index = Angry \times {N}_{1} + Extreme Emotion \times {N}_{1} + Stress \times {N}_{1} + Upset \times {N}_{1} + Embarrassment \times {N}_{1}$$

### Where:

N1 is a normalization parameter, which constrain the value of risk index in the range of 0˜1

In one embodiment, the Decision Quality Value is calculated according to:

$$Decision Quality = 2 - Risk Index + MaturityThinking Index - Emotion Index .$$

In accordance with a second aspect of the present invention, there is provided a method of analyzing voice data, said method comprising:
capturing voice data from a human speaker;
parsing the captured voice data so as to produce a plurality of emotion parameter values indicative of emotional content of the voice data, each parameter value being indicative of the level of an emotion parameter present in the captured voice data; and
generating an indication as to quality of a decision made by the human speaker using a combination of a plurality of the parameter values.

In accordance with a third aspect of the present invention, there is provided a computer program arranged when loaded into a computer to instruct the computer to operate in accordance with a decision analysis system for analyzing voice data captured from a human speaker using a voice collection device, said system being arranged to:
parse the captured voice data so as to produce a plurality of emotion parameter values indicative of emotional content of the voice data, each parameter value being indicative of the level of an emotion parameter present in the captured voice data; and
generate an indication as to quality of a decision made by the human speaker using a combination of a plurality of the parameter values.

In accordance with a fourth aspect of the present invention, there is provided a computer readable medium having computer readable program code embodied therein for causing a computer to operate in accordance with a decision analysis system for analyzing voice data captured from a human speaker using a voice collection device, said system being arranged to:
parse the captured voice data so as to produce a plurality of emotion parameter values indicative of emotional content of the voice data, each parameter value being indicative of the level of an emotion parameter present in the captured voice data; and
generate an indication as to quality of a decision made by the human speaker using a combination of a plurality of the parameter values.

### BRIEF DESCRIPTION OF THE DRAWINGS

The present invention will now be described, by way of example only, with reference to the accompanying drawings, in which:

FIG. 1 is a schematic block diagram of a decision quality analysis system in accordance with an embodiment of the present invention;

FIG. 2 is a flow diagram illustrating operation of the decision quality analysis system shown in FIG. 1;

FIG. 3 is a voice data table which forms part of the decision quality analysis system shown in FIG. 1;

FIG. 4 is a context table which forms part of the decision quality analysis system shown in FIG. 1;

FIG. 5 is a parameter table which forms part of the decision's quality analysis system shown in FIG. 1;

FIG. 6 is a flow diagram illustrating steps of a voice data analysis portion of a method of analyzing a verbal decision in accordance with an embodiment of the present invention;

FIG. 7 is a flow diagram illustrating a decision analysis portion of a method of analyzing a verbal decision in accordance with an embodiment of the present invention;

FIG. 8 is a diagrammatic representation of a report screen of the decision quality analysis system shown in FIG. 1.

### DESCRIPTION OF AN EMBODIMENT OF THE INVENTION

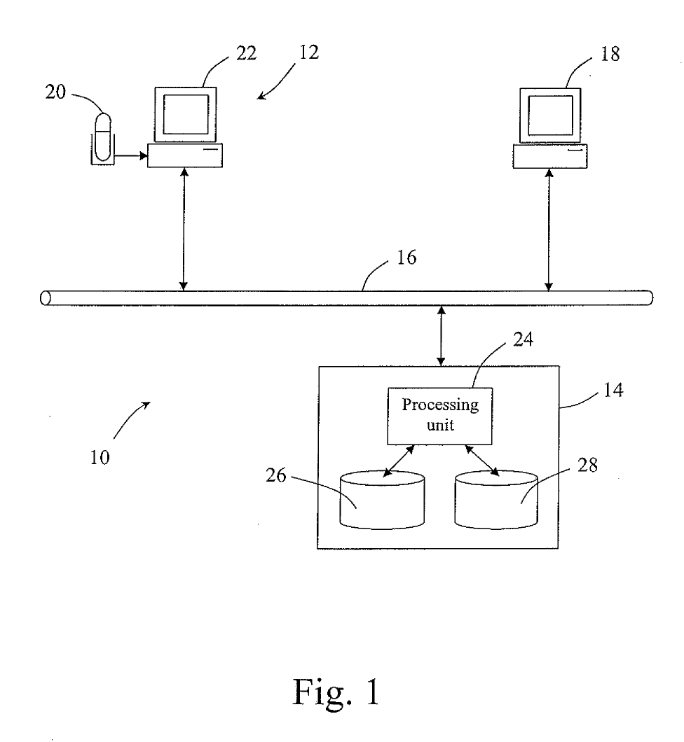

Referring to the drawings, in FIG. 1 there is shown a decision quality analysis system 10 for analyzing voice data input from a person during one or more scenarios, and subsequently analyzing the input voice data so as to provide an assessment as to the quality of one or more decisions made in the or in each of the scenarios.

In the present embodiment, the scenarios are military scenarios and, as such, may include actions like movement, attack, assault, fire and so on. In such military scenarios, subordinates and commanders may respectively receive and give instructions verbally and, accordingly, during training exercises it is important to determine whether decisions made verbally are appropriate or inappropriate, for example because the decision is influenced by excessive emotions.

In another embodiment, the scenarios include a flight combat scenario wherein a pilot continuously communicates with ground control as well as with other pilots in his squadron. In such flight combat scenarios, the pilot can make inappropriate decisions because of over stress and/or excessive emotions.

It will be understood that by analyzing the characteristics of the voice data, an indication can be obtained as to the psychological and emotional condition of the person associated with the voice data. Such considerations are of great importance in military environments as an indication can be provided as to the decision making qualities of a commander, and the psychological and emotional condition of a subordinate.

However, it will be understood that the invention is not limited to military applications, and the invention is equally applicable to other areas, including business areas, for example to analyze voice data captured from business managers and associated subordinates.

As shown in FIG. 1, the decision analysis system 10 comprises a voice input device 12, a processing system 14 and a user analysis terminal 18. The voice input device 12, the processing system 14 and the user analysis terminal 18 are connected together using a communications network 16.

The voice input device 12 is arranged for voice data input from one or more human speakers, in this example using a microphone 20 and a voice collection terminal 22 in the form of a personal computing device, and using the voice collection terminal 22 to receive context information from an operator about the or each scenario associated with the captured voice data.

It will be understood that in any voice data collection operation, one or more scenarios may exist. For example, in a training exercise which includes a military commander and a subordinate, multiple scenarios associated with different military actions such as attack, move, assault, and so on may exist. Using the voice collection terminal 22, an operator is able to enter context data which identifies different types of scenarios and decision making instances which may occur during the scenarios.

Captured voice data and associated entered context data are stored in the processing system 14. In this example, the processing system 14 includes a processing unit 24 which may comprise a microprocessor and associated programs, a voice data repository 26 for storing the voice data and a context data repository 28 for storing the context data.

The processing system 14 is arranged to analyse the captured voice data in association with the context data and provide an indication as to the quality of decisions made by commanders and/or subordinates in different scenarios.

The results of the voice data analysis carried out by the processing system 14 are made available to the user analysis terminal 18, and in this example the user analysis terminal 18 manipulates the analysis results so as to produce user friendly reports.

The user analysis terminal 18 may also be used to modify analysis characteristics used by the processing system 14 in order to improve the accuracy of decision making analysis carried out by the processing system 14.

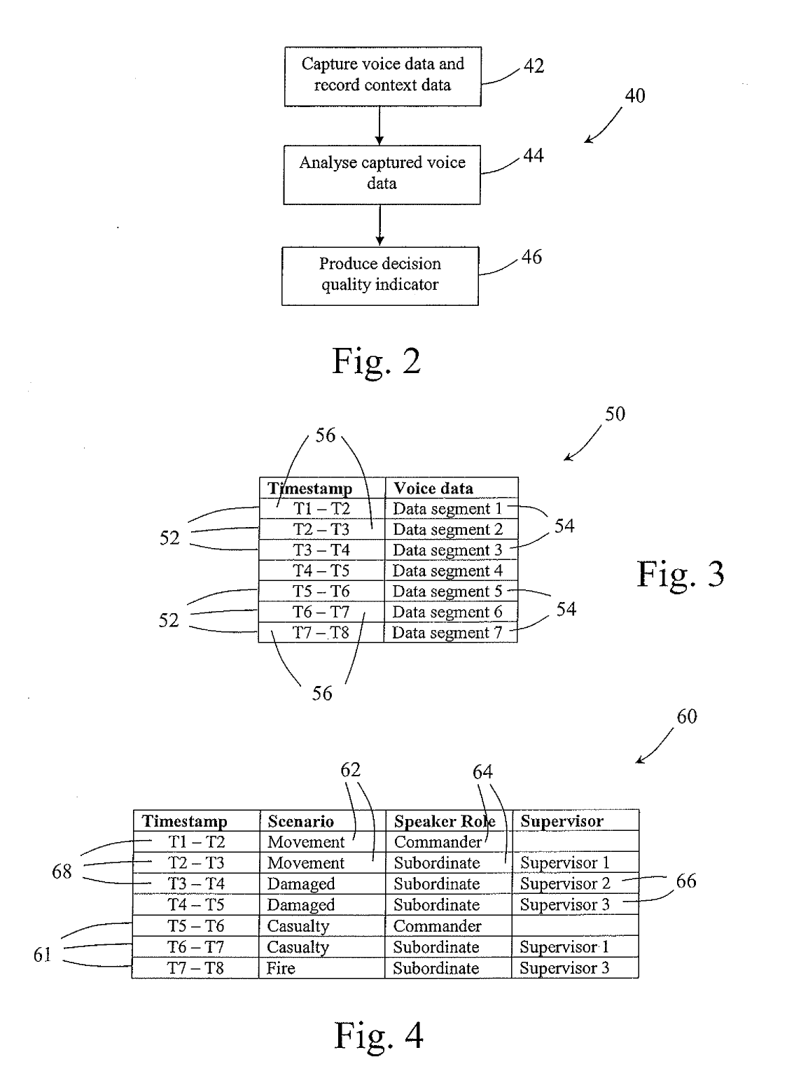

Referring to FIG. 2, a flow diagram 40 is shown which illustrates basic operation of the decision analysis system 10.

As indicated by method steps 42 to 46, the system 10 is arranged to capture voice data and record context data received from an operator, to analyze input voice data using the processing system 14 so as to obtain characteristics of the voice data and, based on the characteristics, to generate an indication as to the quality of decisions made during scenarios covered by the voice data.

As represented by voice data table 50 in FIG. 3, in this example captured voice data is stored in the voice data repository 26 as a plurality of voice data records 52, each of which has a voice data segment 54 and a time stamp 56 which defines start and end times of the voice data segment 54.

As represented by context table 60 in FIG. 4, in this example the context data is stored as a plurality of scenario records 61, each scenario record 61 including scenario data 62 indicative of the type of scenario, speaker role data 64 indicative of the role of the person whose voice data is being analyzed, supervisor data 66 which identifies a supervisor if the role of the speaker is a subordinate, and a time stamp 68 which indicates the start and end times of the scenario record 61.

It will be understood that the time stamps 56 of the data records 52 correspond to the time stamps 68 of the scenario records 61 so that the context data may be associated with the voice data during subsequent analysis.

The voice data stored in the voice data repository 26 is analyzed by the processing system 14 in two stages.

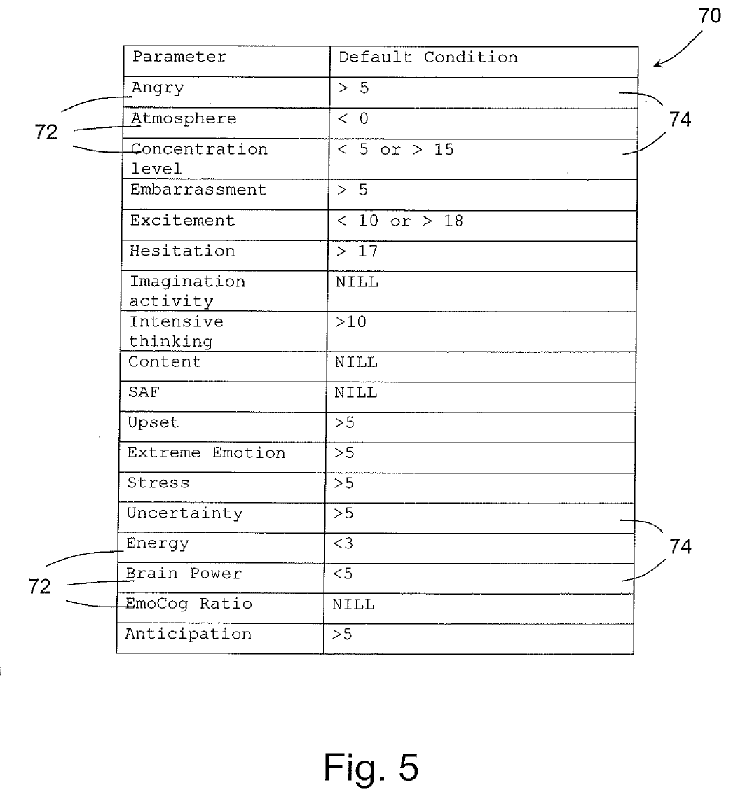

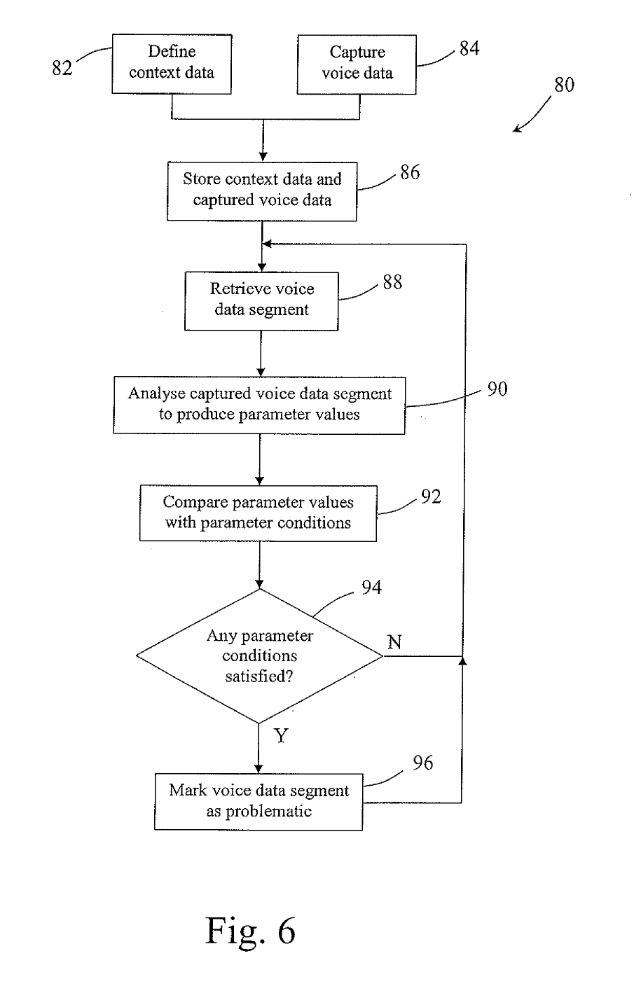

In a first voice data analysis stage illustrated by steps 82 to 96 of the flow diagram 80 in FIG. 6, each segment 54 of the voice data is analyzed using a voice analysis engine, such as the LVA system provided by Nemesysco, to generate numerical values for a plurality of voice emotion parameters. As shown in FIG. 5, such parameters 72 include angry, excitement, stress, anticipation, and so on. The parameters 72 are derived from raw values generated by the voice analysis engine, such raw values including:
SPT: A numeric value describing the relatively high frequency range. This value is associated with an emotion level.
SPJ: A numeric value describing the relatively low frequency range. This value is associated with a cognitive level.
JQ: A numeric value describing the distribution uniformity of the relatively low frequency range. This value is associated with a global stress level.
AVJ: A numeric value describing the average range of the relatively low frequency range. This value is associated with a thinking level.
SOS: Say-Or-Stop is a numeric value describing the changes in the SPT and SPJ values within a single sample sequence. This value is associated with fear and issues which the subject does not want to talk about.
LJ: Measuring the very low frequency range uniformity. This indicator indicates visual memory and imagination activity. In most cases, when the value is high, it indicates deception.
Fmain: The numeric value of the most significant frequency in the frequency range. It is expressed as the percentage of the global contribution to the spectrum. This value is associated with concentration/tension/rejection.
FX: This parameter is an additional frequency indicator. It indicates the number of additional significant frequencies in the spectrum. This value is used as supportive evidence for deception when the value is above middle level.
FQ: This parameter measures uniformity of the spectrum. This value is used as supporting evidence for deception when the value is rising or dropping significantly.
Fflic (Harmonic): Frequency Harmonic Appearance is a numeric value describing the frequency spectrum harmonics. With values above middle values, the sample becomes suspect due to high embarrassment. This value is used to determine whether a voice is shaky, indicating embarrassment and internal conflict in high values.
ANT (Anticipation): The ANT factor is used to evaluate the subject's level of expectation for either feedback from the other party to the conversation or his/her anticipation to the relevant questions which are, in most cases, deceptive. The ANT factor is calculated from the highest three frequencies from the “FRQ. Modulation” and their relative values.

The current practice can associate these raw parameters with emotions:

| Emotion parameters | Raw parameters |
|---|---|
| Hesitation | SPJ, JQ, SOS |
| Stress | JQ Fmain |
| Excitement | FQ, Fflic |
| Intensive Thinking | AVJ, LJ |
| Anticipation | ANT |
| Imagination | LJ |
| Uncertainty | SOS |
| Contentrated | Fmain |
| Angry | SPT, Fmain |
| Extreme emotion | High JQ/Fflic |
| Upset | High SPT and Fflic |
| Embarrassment | High Fflic |

The processing system 14 then compares the generated numerical values with conditions 74 defined for each parameter 72, and if any of the defined conditions 74 are satisfied, a determination is made by the processing system 14 that the decision associated with the voice data segment 54 is potentially problematic.

This analysis is carried out for all of the voice data segments 54.

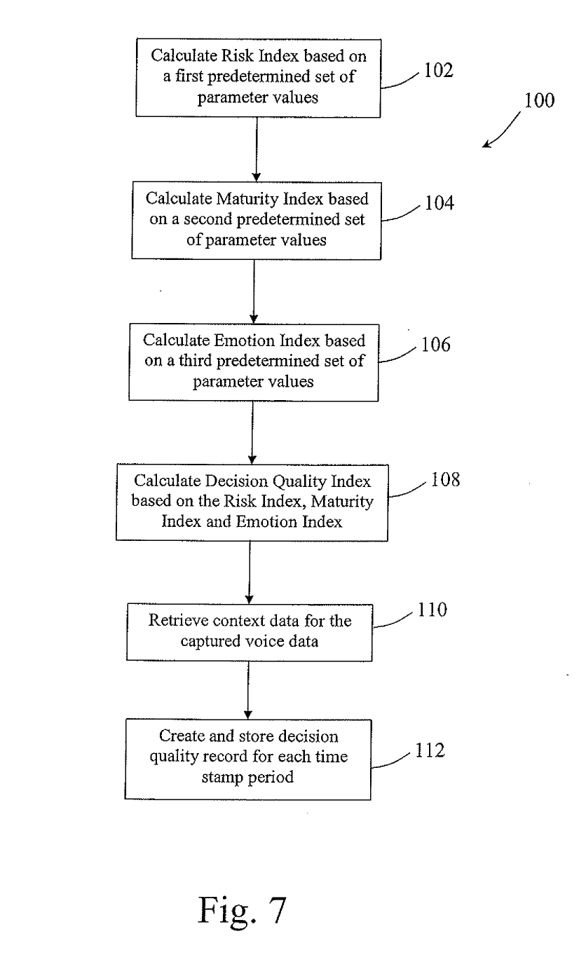

In a second decision analysis stage illustrated by steps 102 to 112 of the flow diagram 100 in FIG. 7, Decision Quality Indices are derived using the parameter values for each of the voice data segments 54 which have been marked as potentially problematic.

In the present example, the Decision Quality Indices are a Risk Index, a Maturity Thinking Index, and an Emotion Index. Each index is a numerical value in the range 0 to 1.

Each of the indices has an associated set of emotion parameters 72 which are defined in the present example as follows:

| | | Level 2 Factors |
|---|---|---|
| Indexes | Level 1 Factor (Primary Factor) | (Secondary factor) |
| Risk Index | Hesitation | Anticipation |
| | Stress | Imagination |
| | Excitement | Uncertainty |
| | Intensive Thinking | |
| Maturity Index | Hesitation | Extreme Emotion |
| | Uncertain | |
| | Excitement | |
| | Concentrated | |
| Emotion Index | Angry | |
| | Extreme Emotion | |
| | Stress | |
| | Upset | |
| | Embarrassment | |

In the present example, the indices are calculated according to the following algorithms:

### Risk Index:

$$Risk Index = Hesitation \times {N}_{1} \times {W}_{h} + Stress \times {N}_{1} \times {W}_{s} + Excitement \times {N}_{1} \times {W}_{e} + Anticipation \times {N}_{1} \times {W}_{a} + Intensive Thinking \times {N}_{1} \times {W}_{int} + Imagination \times {N}_{1} \times {W}_{img} + Uncertain \times {N}_{1 \times } {W}_{u}$$

### Where:

Wₕ+Wₛ+Wₑ+Wᵢₙₜ=0.7

Wₐ+W_{img}+Wᵤ=0.3

N1 is a normalization parameter, which constrain the value of risk index in the range of 0˜1

### Maturity Index:

$$Maturity Index = Hesitation \times {N}_{1} \times {W}_{h} + Uncertain \times {N}_{1} \times {W}_{u} + Excitement \times {N}_{1} \times {W}_{e} + Concentrated \times {N}_{1} \times {W}_{c} + Extreme Emotion \times {N}_{1} \times {W}_{ext}$$

### Where:

Wₕ+Wₑ+Wᵤ+W_{c}=0.9

Wₑₓₜ=0.1

N1 is a normalization parameter, which constrain the value of risk index in the range of 0˜1

### Emotion Index:

$$Emotion Index = Angry \times {N}_{1} + Extreme Emotion \times {N}_{1} + Stress \times {N}_{1} + Upset \times {N}_{1} + Embarrassment \times {N}_{1}$$

### Where:

N1 is a normalization parameter, which constrain the value of risk index in the range of 0˜1

Using the calculated indices, the processing system 14 then calculates a Decision Quality Value using the following formula:

Decision Quality=2−Risk Index+Maturity Index−Emotion Index.

This may be modified by addition of a customised quality factor.

The Decision Quality Value for each problematic voice data segment 54 identified during the first stage of analysis carried out by the processing system 14 is indicative of the quality of decision made during the problematic voice data segment 54. In the present example wherein the scenarios relate to military circumstances involving a commander and/or a subordinate, the Decision Quality Values produced for the identified problematic voice data segments 54 indicate whether decisions made during the problematic voice data segments are inappropriate, for example because the decision is influenced by excessive emotion and/or by the psychological state of the commander and/or subordinate.

The calculated Decision Quality Values are stored by the system 10, for example in the context data repository 28 and, as indicated at step 110 in FIG. 7, context data associated with the problematic voice data segments 54 is then retrieved from the context data repository 28 and associated with the relevant voice data segments 54 using the time stamps 56, 68.

This produces decision data for each identified problematic voice data segment 54 which includes information indicative of the context involved in the problematic voice data segment 54, that is, the type of scenario and role of person speaking; and whether for the scenario involved, the person speaking has made a decision which is appropriate or inappropriate because the decision is influenced by excessive emotion and/or by the psychological condition of the speaker.

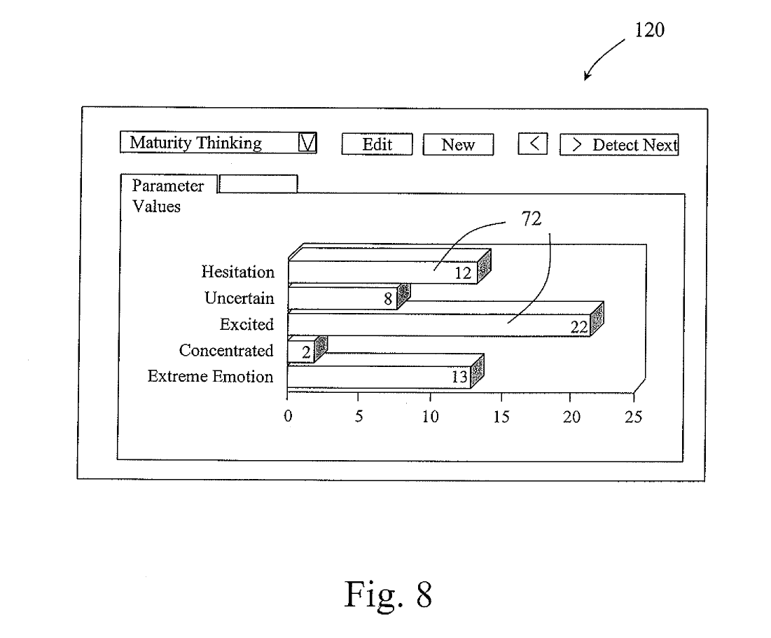

The results may be manipulated by the user analysis terminal 18 and user friendly reports generated. For example, bar charts 120 such as shown in FIG. 8 may be generated to show the parameter values for each of the Risk, Maturity Thinking and Emotion Indices.

The user analysis terminal 18 may also be used to modify operation of the system, for example by modifying the parameter conditions 74 used to identify potentially problematic voice data segments 54, or to modify algorithms used to generate the Risk, Maturity Thinking and Emotion Indices, and/or the algorithm used to generate the Decision Quality Values.

The system may also be arranged such that voice-decision historical data is organized in a way which readily facilitates data mining. For each detected problematic voice segment, the historical data may include the following fields:
Exercise-id
the parameters shown in FIG. 5
the calculated Risking Index
the calculated Maturity Index
the calculated Emotion Index
Record id of “content before voice segment”
Record id of “content after voice segment”

The invention may also be implemented in the form of a computer program or a computer readable medium containing a computer program, the arrangement being such that when the computer program is loaded into a computer, the computer implements a decision analysis system as described above.

Modifications and variations as would be apparent to a skilled addressee are deemed to be within the scope of the present invention.

1. A decision analysis system for analyzing voice data, said system comprising:
a voice collection device arranged to capture voice data from a human speaker; and
a processing system arranged to:
parse the captured voice data so as to produce a plurality of emotion parameter values indicative of emotional content of the voice data, each parameter value being indicative of the level of an emotion parameter present in the captured voice data; and
generate an indication as to quality of a decision made by the human speaker using a combination of a plurality of the parameter values.

2. A decision analysis system as claimed in claim 1, wherein the processing system is arranged to generate a Decision Quality Value indicative of the quality of a decision using a combination of a plurality of the parameter values.

3. A decision analysis system as claimed in claim 1 or claim 2, wherein the processing system is arranged to generate a plurality of Decision Quality Indices.

4. A decision analysis system as claimed in claim 3, wherein the Decision Quality indices comprise a Risk Index, a Maturity Thinking Index and an Emotion Index.

5. A decision analysis system as claimed in claim 4, wherein each Decision Quality Index is a number between 0 and 1.

6. A decision analysis system as claimed in claim 4 or claim 5, wherein the Risk Index is calculated according to:
$$Risk Index = Hesitation \times {N}_{1} \times {W}_{h} + Stress \times {N}_{1} \times {W}_{s} + Excitement \times {N}_{1} \times {W}_{e} + Anticipation \times {N}_{1} \times {W}_{a} + Intensive Thinking \times {N}_{1} \times {W}_{int} + Imagination \times {N}_{1} \times {W}_{img} + Uncertain \times {N}_{1 \times } {W}_{u}$$
Where:
Wₕ+Wₛ+Wₑ+Wᵢₙₜ=0.7
Wₐ+W_{img}+Wᵤ=0.3
N1 is a normalization parameter, which constrain the value of risk index in the range of 0˜1

7. A decision analysis system as claimed in any one of claims 4 to 6, wherein the Maturity Thinking Index is calculated according to:
$$Maturity Index = Hesitation \times {N}_{1} \times {W}_{h} + Uncertain \times {N}_{1} \times {W}_{u} + Excitement \times {N}_{1} \times {W}_{e} + Concentrated \times {N}_{1} \times {W}_{c} + Extreme Emotion \times {N}_{1} \times {W}_{ext}$$
Where:
Wₕ+Wₑ+Wᵤ+W_{c}=0.9
Wₑₓₜ=0.1
N1 is a normalization parameter, which constrain the value of risk index in the range of 0˜1

8. A decision analysis system as claimed in any one of claims 4 to 7, wherein the Emotion Index is calculated according to:
$$Emotion Index = Angry \times {N}_{1} + Extreme Emotion \times {N}_{1} + Stress \times {N}_{1} + Upset \times {N}_{1} + Embarrassment \times {N}_{1}$$
Where:
N₁ is a normalized parameter between 0 and 1

9. A decision analysis system as claimed in any one of the preceding claims, wherein the captured voice data is parsed so as to produce a plurality of emotion parameter values using Nemesysco's LVA.

10. A decision analysis system as claimed in any one of claims 4 to 9 when dependent on claim 2, wherein the Decision Quality Value is calculated according to:
$$Decision Quality = 2 - Risk Index + MaturityThinking Index - Emotion Index .$$

11. A method of analyzing voice data, said method comprising:
capturing voice data from a human speaker;
parsing the captured voice data so as to produce a plurality of emotion parameter values indicative of emotional content of the voice data, each parameter value being indicative of the level of an emotion parameter present in the captured voice data; and
generating an indication as to quality of a decision made by the human speaker using a combination of a plurality of the parameter values.

12. A method as claimed in claim 11, comprising generating a Decision Quality Value indicative of the quality of a decision using a combination of a plurality of the parameter values.

13. A method as claimed in claim 11 or claim 12, comprising generating a plurality of Decision Quality Indices.

14. A method as claimed in claim 13, wherein the Decision Quality Indices comprise a Risk Index, a Maturity Thinking Index and an Emotion Index.

15. A method as claimed in claim 14, wherein each Decision Quality Index is a number between 0 and 1.

16. A method as claimed in claim 14 or claim 15, comprising calculating the Risk Index according to:
$$Risk Index = Hesitation \times {N}_{1} \times {W}_{h} + Stress \times {N}_{1} \times {W}_{s} + Excitement \times {N}_{1} \times {W}_{e} + Anticipation \times {N}_{1} \times {W}_{a} + Intensive Thinking \times {N}_{1} \times {W}_{int} + Imagination \times {N}_{1} \times {W}_{img} + Uncertain \times {N}_{1 \times } {W}_{u}$$
Where:
Wₕ+Wₛ+Wₑ+Wᵢₙₜ=0.7
Wₐ+W_{img}+Wᵤ=0.3
N1 is a normalization parameter, which constrain the value of risk index in the range of 0˜1

17. A method as claimed in any one of claims 14 to 16, comprising calculating the Maturity Thinking Index according to:
$$Maturity Index = Hesitation \times {N}_{1} \times {W}_{h} + Uncertain \times {N}_{1} \times {W}_{u} + Excitement \times {N}_{1} \times {W}_{e} + Concentrated \times {N}_{1} \times {W}_{c} + Extreme Emotion \times {N}_{1} \times {W}_{ext}$$
Where:
Wₕ+Wₑ+Wᵤ+W_{c}=0.9
Wₑₓₜ=0.1
N1 is a normalization parameter, which constrain the value of risk index in the range of 0˜1

18. A method as claimed in any one of claims 14 to 17, comprising calculating the Emotion Index according to:
$$Emotion Index = Angry \times {N}_{1} + Extreme Emotion \times {N}_{1} + Stress \times {N}_{1} + Upset \times {N}_{1} + Embarrassment \times {N}_{1}$$
Where:
N1 is a normalization parameter, which constrain the value of risk index in the range of 0˜1

19. A method as claimed in any one of the preceding claims, comprising parsing the captured voice data so as to produce a plurality of emotion parameter values using Nemesysco's LVA.

20. A method as claimed in any one of claims 14 to 19 when dependent on claim 12, comprising calculating the Decision Quality Value according to:
Decision Quality=2−Risk Index+MaturityThinking Index−Emotion Index.

21. A computer program arranged when loaded into a computer to instruct the computer to operate in accordance with a decision analysis system for analyzing voice data captured from a human speaker using a voice collection device, said system being arranged to:
parse the captured voice data so as to produce a plurality of emotion parameter values indicative of emotional content of the voice data, each parameter value being indicative of the level of an emotion parameter present in the captured voice data; and
generate an indication as to quality of a decision made by the human speaker using a combination of a plurality of the parameter values.

22. A computer readable medium having computer readable program code embodied therein for causing a computer to operate in accordance with a decision analysis system for analyzing voice data captured from a human speaker using a voice collection device, said system being arranged to:
parse the captured voice data so as to produce a plurality of emotion parameter values indicative of emotional content of the voice data, each parameter value being indicative of the level of an emotion parameter present in the captured voice data; and
generate an indication as to quality of a decision made by the human speaker using a combination of a plurality of the parameter values.
